(19) United States
(12) Patent Application Publication
(10) Pub. No.: US 2026/0212766 A1
(43) Pub. Date: Jul. 23, 2026

(54) SYSTEM, METHOD, AND COMPUTER PROGRAM FOR FLIGHT VEHICLE PATH PREDICTION

(71) Applicant: SK TELECOM CO., LTD., Seoul (KR)

(72) Inventors: Donghun KANG, Seoul (KR); Yeongeol RYU, Seoul (KR)

(21) Appl. No.: 19/570,504

(22) Filed: Mar. 18, 2026

Related U.S. Application Data
(63) Continuation of application No. PCT/KR2024/016096, filed on Oct. 22, 2024.

(30) Foreign Application Priority Data
Oct. 31, 2023 (KR) 10-2023-0148531

(51) Int. Cl. G08G 5/32; G06N 3/0442; G08G 5/76; G08G 5/80; G08G 5/90

(52) U.S. Cl. CPC G08G 5/32; G06N 3/0442; G08G 5/76; G08G 5/80; G08G 5/90

(57) ABSTRACT

A technology for predicting a flight path of an aircraft, such as a UAM aircraft, based on an artificial intelligence model is disclosed. A method to be performed by a flight path prediction model training apparatus comprises acquiring a plurality of training data sets including performance information of at least one aircraft, fuel information, weather information according to a position of the at least one aircraft, route deviation information, performing preprocessing on the plurality of training data sets, and training a flight path prediction model to predict a flight path of an aircraft based on the preprocessed plurality of training data sets.

### CROSS-REFERENCE TO RELATED APPLICATION

This application is a continuation of PCT International Patent Application No. PCT/KR2024/016096, filed on Oct. 22, 2024, which claims the benefit of priority to Korean Patent Application No. 10-2023-0148531, filed on Oct. 31, 2023 in the Korean Intellectual Property Office. The aforementioned applications are hereby incorporated by reference in their entireties.

### TECHNICAL FIELD

The present disclosure relates to a technology for predicting a flight path of an aircraft, such as a UAM aircraft, based on an artificial intelligence model.

### BACKGROUND

In air traffic control, flight path prediction for aircraft such as those in UAM (urban air mobility) is very important because accidents may be prevented by detecting the risk of collisions and route deviations in advance. Recently, extensive research has been conducted on predicting flight paths using deep learning methods, but conventional methods predict a flight path using only aircraft track information such as aircraft position, direction, and speed, which limits the ability to infer a pilot's flight intention. Furthermore, from the perspective of conventional ground control, it is difficult to know detailed control information or the pilot's flight intention due to limitations of long-range communication, and accurate flight path prediction is difficult because future flight paths are predicted based on past flight trajectories.

### SUMMARY

An object of an embodiment is to provide a technology for predicting a flight path based on various information such as performance, weather, and flight status of an aircraft.

An object of an embodiment is to provide a technology for predicting a flight path based on an artificial intelligence model.

According to an embodiment, a method to be performed by a flight path prediction model training apparatus, the method comprises: acquiring a plurality of training data sets including performance information, fuel information, weather information according to the position of at least one aircraft, and route deviation information of the at least one aircraft; performing preprocessing on the plurality of training data sets; and training a flight path prediction model to predict a flight path of an aircraft based on the preprocessed plurality of training data sets.

In an embodiment, the performing of the preprocessing may include filtering at least one training data set that includes route deviation information exceeding a preset route deviation threshold from the plurality of training data sets, and the training of the flight path prediction model may include training the flight path prediction model based on the filtered plurality of training data sets.

In an embodiment, the performing of the preprocessing may include normalizing the performance information, the fuel information, the weather information according to the position of the at least one aircraft, and the route deviation information included in the plurality of training data sets.

In an embodiment, the flight path prediction model may be a time-series data prediction model.

In an embodiment, the time-series data prediction model may be a Long Short-Term Memory (LSTM) or a Recurrent Neural Network (RNN).

According to another embodiment, a method to be performed by an aircraft flight path prediction apparatus, the method comprises: acquiring performance information of a target aircraft, weather information at a first position of the target aircraft, and route deviation information of the target aircraft; and predicting a flight path of the target aircraft from preprocessed performance information, weather information, and route deviation information, based on a pre-trained flight path prediction model.

In an embodiment, the method may further comprise acquiring flight plan information of the target aircraft and flight information of the target aircraft at the first position, wherein the acquiring of the performance information of the target aircraft, the weather information at the first position of the target aircraft, and the route deviation information may include calculating the route deviation information based on the flight plan information and the flight information.

In an embodiment, the performance information may include at least one of a maximum take-off weight and a cruise speed, the weather information may include at least one of a wind direction and a wind speed, the route deviation information may be a conformance metric including at least one of Cross-Track Error (CTE), Along-Track Error (ATE), Horizontal Error (HE), Altitude Error (AE), Euclidean Error (EE), and Direction Angle Error (DAE), and the flight information may include at least one of a latitude, a longitude, a bearing, a speed, a remaining fuel amount, and a heading direction of the target aircraft.

According to another embodiment, a flight path prediction model training apparatus comprises: a memory including instructions; and a processor that executes the instructions to perform a method comprising: acquiring a plurality of training data sets including performance information of at least one aircraft, fuel information, weather information according to a position of the at least one aircraft, and route deviation information of the at least one aircraft; performing preprocessing on the plurality of training data sets; and training a flight path prediction model to predict a flight path of an aircraft based on the preprocessed plurality of training data sets.

According to another embodiment, there is provided a non-transitory computer-readable storage medium storing computer-executable instructions, wherein the computer-executable instructions, when executed by a processor, cause the processor to perform a method comprising: acquiring a plurality of training data sets including performance information of at least one aircraft, fuel information, weather information according to a position of the at least one aircraft, and route deviation information of the at least one aircraft; performing preprocessing on the plurality of training data sets; and training the flight path prediction model to predict a flight path of an aircraft based on the preprocessed plurality of training data sets.

According to an embodiment, it is possible to predict a flight path based on various information such as performance, weather, and flight status of an aircraft.

Furthermore, according to another embodiment, a technology for predicting a flight path based on an artificial intelligence model is provided.

### BRIEF DESCRIPTION OF THE DRAWINGS

FIG. 1 is a diagram illustrating an aircraft flight path prediction system according to an embodiment.

FIG. 2 is a block diagram of a flight path prediction model training apparatus according to an embodiment.

FIG. 3 is a flowchart of a flight path prediction model training method according to an embodiment.

FIG. 4 is a block diagram of an aircraft flight path prediction apparatus according to an embodiment.

FIG. 5 is a flowchart of an aircraft flight path prediction method according to an embodiment.

FIG. 6 is a diagram for explaining an example of route deviation information according to an embodiment.

FIG. 7 is a diagram for explaining flight path prediction by a prediction model according to an embodiment.

FIG. 8 is a block diagram of an aircraft flight path prediction system according to another embodiment.

### DETAILED DESCRIPTION

Advantages and features of the disclosure, and methods for achieving them, will become apparent by referring to the embodiments described in detail below with reference to the accompanying drawings. However, the disclosure is not limited to the embodiments disclosed below and may be implemented in various forms; these embodiments are provided only to make this disclosure complete and to fully inform those skilled in the art of the scope of the invention, and the scope of the invention is defined only by the claims.

In describing the embodiments, detailed descriptions of known functions or configurations will be omitted unless they are actually necessary for the description of the embodiments. Also, the terms used below are defined in consideration of the functions in the embodiments and may vary according to the intention or custom of a user or operator. Therefore, the definitions should be made based on the content throughout this specification.

Hereinafter, terms such as ‘-unit’ or ‘-device’ refer to a unit that processes at least one function or operation, and this may be implemented as hardware, software, or a combination of hardware and software.

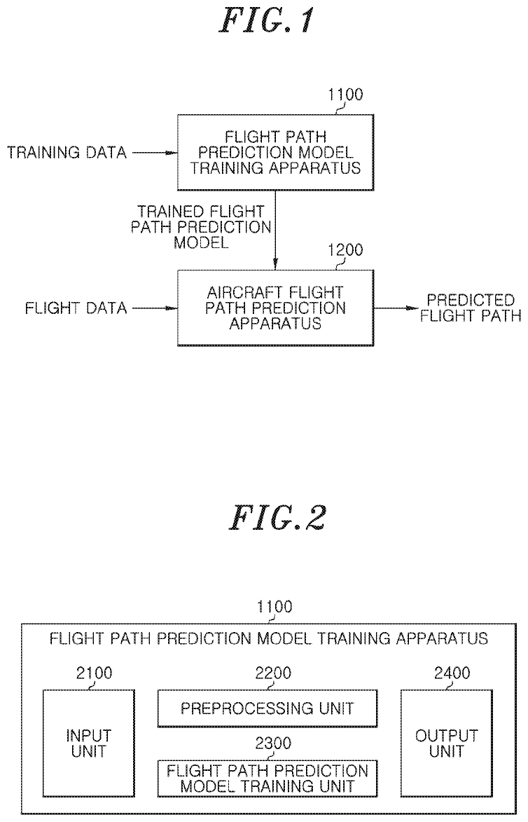

FIG. 1 is a diagram illustrating an aircraft flight path prediction system according to an embodiment.

Referring to FIG. 1, an aircraft flight path prediction system 1000 according to an embodiment may include a flight path prediction model training apparatus 1100 and an aircraft flight path prediction apparatus 1200.

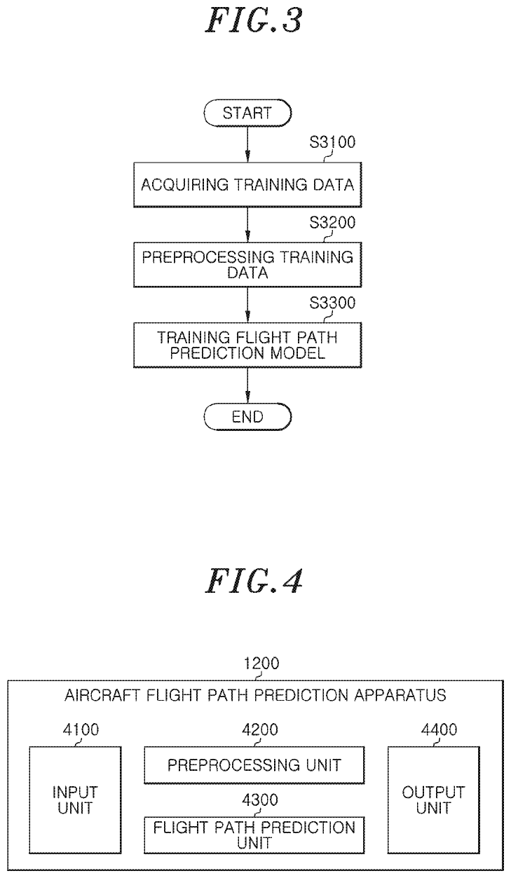

The flight path prediction model training apparatus 1100 may receive training data used for predicting the flight path of an aircraft and may train a flight path prediction model to predict the flight path of the aircraft based on the input training data. The flight path prediction model training apparatus 1100 may transmit the trained flight path prediction model to the aircraft flight path prediction apparatus 1200. The specific configuration and operation method of the flight path prediction model training apparatus 1100 will be described below with reference to FIGS. 2 and 3.

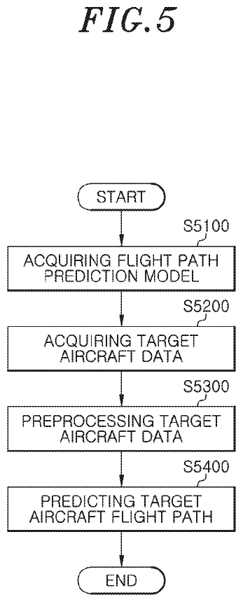

The aircraft flight path prediction apparatus may acquire the trained flight path prediction model from the flight path prediction model training apparatus 1100. The aircraft flight path prediction apparatus may receive flight data of an aircraft for which a flight path is to be predicted, and may generate a predicted flight path, which is a predicted flight path of the aircraft, from the input flight data using the flight path prediction model. The specific configuration and operation method of the aircraft flight path prediction apparatus will be described below with reference to FIGS. 4 and 5.

FIG. 2 is a block diagram of a flight path prediction model training apparatus according to an embodiment.

Referring to FIG. 2, a flight path prediction model training apparatus 1100 according to an embodiment may include an input unit 2100, a preprocessing unit 2200, a flight path prediction model training unit 2300, and an output unit 2400.

The input unit 2100 may receive training data used for training the flight path prediction model.

In an embodiment, the training data may include performance information of at least one aircraft, position information of the at least one aircraft over time, weather information, route deviation information, and the like.

In an embodiment, the performance information may refer to information about the aircraft's own specifications, such as the maximum take-off weight (MTOW), cruise speed, and travelable distance of at least one aircraft.

In an embodiment, the weather information may refer to information about weather conditions such as wind direction, wind speed, and weather.

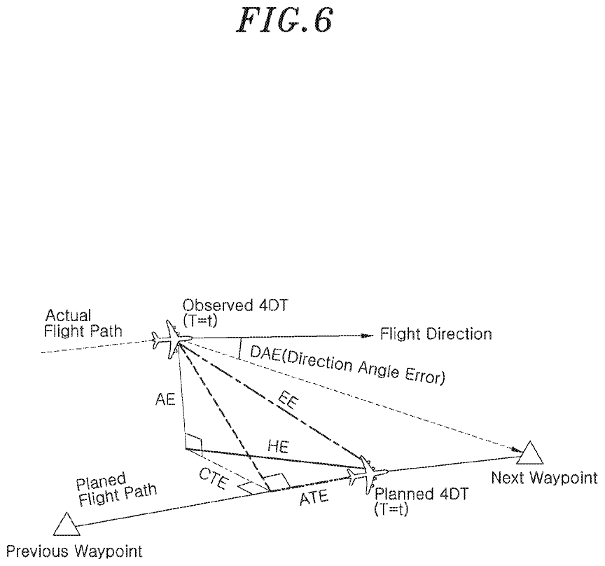

In an embodiment, the route deviation information may refer to a conformance metric that includes at least one of Cross-Track Error (CTE), Along-Track Error (ATE), Horizontal Error (HE), Altitude Error (AE), Euclidean Error (EE), and Direction Angle Error (DAE) for at least one aircraft, as shown in FIG. 6. In an embodiment, the training data may further include flight information and flight plan information. Here, the flight information may refer to information about the flight status of at least one aircraft, such as latitude, longitude, bearing, speed, heading direction, remaining fuel, etc. Furthermore, the flight plan information may refer to information such as a flight plan route, departure point, destination, etc.

In an embodiment, the input unit 2100 may receive data from an external device (not shown, e.g., meteorological agency, control tower, aircraft, etc.) using a wired/wireless communication method.

In an embodiment, the input unit 2100 may receive a command necessary for training the flight path prediction model from a user using a user interface or the like (not shown).

The preprocessing unit 2200 may perform preprocessing on the training data used for training the flight path prediction model.

In an embodiment, the preprocessing unit 2200 may preprocess the training data by normalizing the training data used for training the prediction model.

In an embodiment, if the training data does not include route deviation information, the preprocessing unit 2200 may generate route deviation information by calculating CTE (Cross-Track Error), ATE (Along-Track Error), HE (Horizontal Error), AE (Altitude Error), EE (Euclidean Error), DAE (Direction Angle Error), etc., based on the flight information and the flight plan information. At this time, the preprocessing unit 2200 may include the generated route deviation information in the training data.

In an embodiment, the preprocessing unit 2200 may preprocess the data of a target aircraft to be input to the trained prediction model for predicting the flight path of the target aircraft, by normalizing the data.

In an embodiment, the preprocessed training data and the data of the target aircraft may be expressed as shown in Equation 1 below.

$$\text{?} = [ \text{?} heading \text{?} fuel\_level \text{?} CTE ATE \text{?} \qquad [ Equation 1 ]$$

$$\text{?} \text{indicates text missing or illegible when filed}$$

Here, the information included in the preprocessed training data and the data of the target aircraft may include 14 pieces of information: latitude, longitude, altitude, bearing, speed, remaining fuel, wind direction, wind speed, CTE (Cross-Track Error), ATE (Along-Track Error), AE (Altitude Error), MTOW (Maximum Take-off Weight), Cruise speed, and Range (travelable distance). Furthermore, the data from the past time t-9 with respect to a reference, time t may be expressed as p^{t-9}, p^{t-8}, . . . , p^{t} respectively.

Furthermore, the preprocessing unit 2200 may perform filtering on the training data by filtering out data that does not correspond to a normal flight state from the data included in the training data, based on a preset threshold. This is to exclude, from the training of the flight path prediction model, training data that does not include data corresponding to a normal flight state.

In an embodiment, the preprocessing unit 2200 may exclude, from the training of the flight path prediction model, training data that includes route deviation information exceeding a preset route deviation threshold among the route deviation information included in the training data. This is because if the route deviation information, which indicates deviation from a flight plan, exceeds a route deviation threshold, it cannot be considered a normal flight state. At this time, a different route deviation threshold may be set for each of CTE (Cross-Track Error), ATE (Along-Track Error), HE (Horizontal Error), AE (Altitude Error), EE (Euclidean Error), and DAE (Direction Angle Error) included in the conformance metric.

In an embodiment, the preprocessing unit 2200 may exclude, from the training of the flight path prediction model, training data that includes fuel information (e.g., remaining battery) that is less than a preset fuel threshold among the fuel information included in the training data. This is because if the fuel amount is insufficient to fly to the destination, it is a situation where an emergency landing must be made at a location other than the destination, so it cannot be considered a normal flight state.

Furthermore, the preprocessing unit 2200 may standardize the units of the training data. Specifically, if the training data includes information in the WGS84 coordinate system using units such as degrees, feet, and knots (kts), the preprocessing unit 2200 may convert them into units such as meters (m), radians (rad), and speed (m/s).

The flight path prediction model training unit 2300 may train a flight path prediction model used for predicting the flight path of a target aircraft.

In an embodiment, the flight path prediction model may be a time-series data prediction model that processes time-series data, such as a Long Short-Term Memory (LSTM) or a Recurrent Neural Network (RNN).

In an embodiment, the flight path prediction model may be a sequence-to-sequence type model composed of two modules, an Encoder and a Decoder. Here, each of the Encoder and the Decoder may be composed of two layers of LSTM. The Encoder receives time-series input data in chronological order, passes it through two LSTM networks to output a Hidden State that is a compressed form of all information, and the Decoder may sequentially predict the results by passing the last value of the input data and the output of the encoder through two LSTM networks.

In an embodiment, the flight path prediction model training unit 2300 may train the flight path prediction model to predict the flight path a target aircraft is flying, based on the training data.

In an embodiment, the flight path prediction model training unit 2300 may train the flight path prediction model based on the preprocessed training data.

In an embodiment, the flight path prediction model training unit 2300 may use MSE loss during the training process of the prediction model, train for 3000 epochs, and the learning rate may be adjusted between 0.001 and 0.01.

The output unit 2400 may transmit the flight path prediction model to an external device (not shown) using a wired/wireless communication method.

In an embodiment, the output unit 2400 may transmit the trained flight path prediction model to the aircraft flight path prediction apparatus 1200.

FIG. 3 is a flowchart of a flight path prediction model training method according to an embodiment.

Hereinafter, the method will be described as being performed by the flight path prediction model training apparatus 1100 shown in FIG. 2 as an example.

Referring to FIG. 3, in step S3100, the flight path prediction model training apparatus 1100 may acquire training data used for training the flight path prediction model.

In an embodiment, the training data may include performance information of at least one aircraft, position information of the at least one aircraft over time, weather information, route deviation information, and the like.

In an embodiment, the performance information may refer to information about the aircraft's own specifications, such as the maximum take-off weight (MTOW), cruise speed, and travelable distance of at least one aircraft.

In an embodiment, the weather information may refer to information about weather conditions such as wind direction, wind speed, and weather.

In an embodiment, the route deviation information may refer to a conformance metric that includes at least one of Cross-Track Error (CTE), Along-Track Error (ATE), Horizontal Error (HE), Altitude Error (AE), Euclidean Error (EE), and Direction Angle Error (DAE) for at least one aircraft, as shown in FIG. 6.

In an embodiment, the training data may further include flight information and flight plan information. Here, the flight information may refer to information about the flight status of at least one aircraft, such as latitude, longitude, bearing, speed, heading direction, remaining fuel, etc. Furthermore, the flight plan information may refer to information such as a flight plan route, departure point, destination, etc.

In an embodiment, the flight path prediction model training apparatus 1100 may receive data from an external device (not shown, e.g., meteorological agency, control tower, aircraft, etc.) using a wired/wireless communication method.

In step S3200, the flight path prediction model training apparatus 1100 may perform preprocessing on the training data used for training the flight path prediction model.

In an embodiment, the flight path prediction model training apparatus 1100 may preprocess the training data by normalizing the training data used for training the prediction model.

In an embodiment, if the training data does not include route deviation information, the flight path prediction model training apparatus 1100 may generate route deviation information by calculating CTE (Cross-Track Error), ATE (Along-Track Error), HE (Horizontal Error), AE (Altitude Error), EE (Euclidean Error), DAE (Direction Angle Error), etc., based on the flight information and the flight plan information.

In an embodiment, the flight path prediction model training apparatus 1100 may preprocess the data of a target aircraft to be input to the trained prediction model for predicting the flight path of the target aircraft, by normalizing the data.

Furthermore, the flight path prediction model training apparatus 1100 may perform filtering on the training data by filtering out data that does not correspond to a normal flight state from the data included in the training data, based on a preset threshold. This is to exclude, from the training of the flight path prediction model, training data that does not include data corresponding to a normal flight state.

In an embodiment, the flight path prediction model training apparatus 1100 may exclude, from the training of the flight path prediction model, training data that includes route deviation information exceeding a preset route deviation threshold among the route deviation information included in the training data. This is because if the route deviation information, which indicates deviation from a flight plan, exceeds a route deviation threshold, it cannot be considered a normal flight state.

In an embodiment, the flight path prediction model training apparatus 1100 may exclude, from the training of the flight path prediction model, training data that includes fuel information (e.g., remaining battery) that is less than a preset fuel threshold among the fuel information included in the training data. This is because if the fuel amount is insufficient to fly to the destination, it is a situation where an emergency landing must be made at a location other than the destination, so it cannot be considered a normal flight state.

Furthermore, the flight path prediction model training apparatus 1100 may standardize the units of the training data. Specifically, if the training data includes information in the WGS84 coordinate system using units such as degrees, feet, and knots (kts), the flight path prediction model training apparatus 1100 may convert them into units such as meters (m), radians (rad), and speed (m/s).

In step S3300, the flight path prediction model training apparatus 1100 may train a flight path prediction model used for predicting the flight path of a target aircraft.

In an embodiment, the flight path prediction model may be a time-series data prediction model that processes time-series data, such as a Long Short-Term Memory (LSTM) or a Recurrent Neural Network (RNN).

In an embodiment, the flight path prediction model may be a sequence-to-sequence type model composed of two modules, an Encoder and a Decoder. Here, each of the Encoder and the Decoder may be composed of two layers of LSTM. The Encoder receives time-series input data in chronological order, passes it through two LSTM networks to output a Hidden State that is a compressed form of all information, and the Decoder can sequentially predict the results by passing the last value of the input data and the output of the encoder through two LSTM networks.

In an embodiment, the flight path prediction model training apparatus 1100 may train the flight path prediction model to predict the flight path a target aircraft is flying, based on the training data.

In an embodiment, the flight path prediction model training apparatus 1100 may train the flight path prediction model based on the preprocessed training data.

In an embodiment, the flight path prediction model training apparatus 1100 may use MSE loss during the training process of the prediction model, train for 3000 epochs, and the learning rate may be adjusted between 0.001 and 0.01.

FIG. 4 is a block diagram of an aircraft flight path prediction apparatus according to an embodiment.

Referring to FIG. 4, an aircraft flight path prediction apparatus 1200 according to an embodiment may include an input unit 4100, a preprocessing unit 4200, a flight path prediction unit 4300, and an output unit 4400.

The input unit 4100 may receive data of a target aircraft, which is the subject of the flight path prediction.

In an embodiment, the data of the target aircraft may include performance information of the target aircraft, weather information according to the position of at least one aircraft, route deviation information, and the like.

In an embodiment, the data of the target aircraft may include performance information of the target aircraft, position information of the at least one aircraft over time, weather information, route deviation information, and the like.

In an embodiment, the performance information of the target aircraft may refer to information about the aircraft's own specifications, such as the maximum take-off weight (MTOW), cruise speed, and travelable distance of the target aircraft.

In an embodiment, the weather information of the target aircraft may refer to information about weather conditions such as wind direction, wind speed, and weather.

In an embodiment, the route deviation information may refer to a conformance metric that includes at least one of Cross-Track Error (CTE), Along-Track Error (ATE), Horizontal Error (HE), Altitude Error (AE), Euclidean Error (EE), and Direction Angle Error (DAE) for the target aircraft.

In an embodiment, the data of the target aircraft may further include flight information and flight plan information of the target aircraft. Here, the flight information may refer to information about the flight status of the target aircraft, such as latitude, longitude, bearing, speed, heading direction, remaining fuel, etc. Furthermore, the flight plan information may refer to information such as a flight plan route, departure point, destination, etc.

In an embodiment, the input unit 4100 may receive data from an external device (not shown, e.g., meteorological agency, control tower, aircraft, etc.) using a wired/wireless communication method.

In an embodiment, the input unit 4100 may receive a command necessary for predicting the flight path of the aircraft from a user using a user interface or the like (not shown).

Furthermore, the input unit 4100 may acquire a pre-trained flight path prediction model from a prediction model training apparatus.

The preprocessing unit 4200 may preprocess the data of the target aircraft to be input to the trained prediction model for predicting the flight path of the target aircraft, by normalizing the data.

In an embodiment, the data of the target aircraft may be expressed as in Equation 1 above.

Furthermore, the preprocessing unit 4200 may standardize the units of the data of the target aircraft. Specifically, if the training data includes information in the WGS84 coordinate system using units such as degrees, feet, and knots (kts), the preprocessing unit 4200 may convert them into units such as meters (m), radians (rad), and speed (m/s).

The flight path prediction unit 4300 may generate a predicted flight path of the target aircraft from the data of the target aircraft, based on the pre-trained flight path prediction model.

In an embodiment, the flight path prediction unit 4300 may predict the flight path of the target aircraft from the preprocessed data of the aircraft, using the trained flight path prediction model.

In an embodiment, the flight path of the target aircraft predicted by the flight path prediction model may be expressed as shown in Equation 2 below.

$${O}^{t} = {[ \begin{matrix}lat & lon & alt\end{matrix} ]}^{T} \qquad [ Equation 2 ]$$

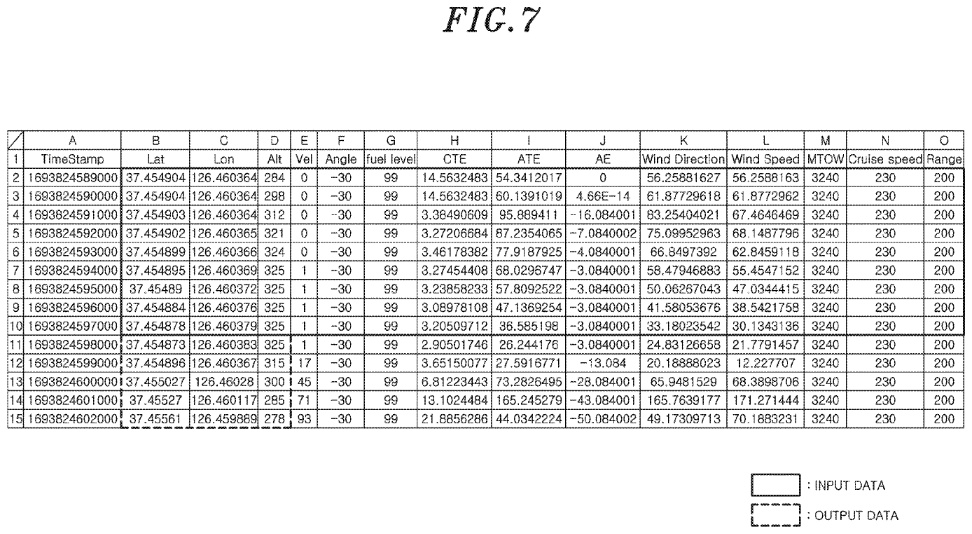

The prediction result o^{t} by the prediction model may include three pieces of information: latitude, longitude, and altitude. As shown in FIG. 7, when the data of the target, aircraft (input data) p^{t-9}, p^{t-8}, . . . p^{t} from the past time t-9 with respect to a reference time t is input, the prediction model predicts the output data O^{t+1}, o^{t+2}, O^{t+5} which is the latitude, longitude, and altitude of the target aircraft from time t+1 to t+5, thereby enabling the prediction of the flight path. The output unit 4400 may output the result of predicting the flight path for the target aircraft in a form that a user can perceive visually or audibly. In an embodiment, the output unit 4400 may transmit the result of predicting the flight path to an external device (not shown) using a wired/wireless communication method.

The output unit 4400 may output the result of predicting the flight path for the target aircraft in a form that a user can perceive visually or audibly.

In an embodiment, the output unit 4400 may transmit the result of predicting the flight path to an external device (not shown) using a wired/wireless communication method.

FIG. 5 is a flowchart of an aircraft flight path prediction method according to an embodiment.

Hereinafter, the method will be described as being performed by the aircraft flight path prediction apparatus 1200 shown in FIG. 4 as an example.

Referring to FIG. 5, in step S5100, the aircraft flight path prediction apparatus 1200 may acquire a flight path prediction model trained by the flight path prediction model training apparatus 1100 from the flight path prediction model training apparatus 1100.

In step S5200, the aircraft flight path prediction apparatus 1200 may acquire data of a target aircraft.

In an embodiment, the data of the target aircraft may include performance information of the target aircraft, weather information according to the position of at least one aircraft, route deviation information, and the like.

In an embodiment, the data of the target aircraft may include performance information of the target aircraft, position information of the at least one aircraft over time, weather information, route deviation information, and the like.

In an embodiment, the performance information of the target aircraft may refer to information about the aircraft's own specifications, such as the maximum take-off weight (MTOW), cruise speed, and travelable distance of the target aircraft.

In an embodiment, the weather information of the target aircraft may refer to information about weather conditions such as wind direction, wind speed, and weather.

In an embodiment, the route deviation information may refer to a conformance metric that includes at least one of Cross-Track Error (CTE), Along-Track Error (ATE), Horizontal Error (HE), Altitude Error (AE), Euclidean Error (EE), and Direction Angle Error (DAE) for the target aircraft.

In an embodiment, the data of the target aircraft may further include flight information and flight plan information of the target aircraft. Here, the flight information may refer to information about the flight status of the target aircraft, such as latitude, longitude, bearing, speed, heading direction, remaining fuel, etc. Furthermore, the flight plan information may refer to information such as a flight plan route, departure point, destination, etc.

In step S5300, the aircraft flight path prediction apparatus 1200 may preprocess the data of the target aircraft to be input to the trained prediction model for predicting the flight path of the target aircraft, by normalizing the data.

In an embodiment, the data of the target aircraft may be expressed as in Equation 1 above.

Furthermore, the aircraft flight path prediction apparatus 1200 may standardize the units of the data of the target aircraft. Specifically, if the training data includes information in the WGS84 coordinate system using units such as degrees, feet, and knots (kts), the preprocessing unit 4200 may convert them into units such as meters (m), radians (rad), and speed (m/s).

In step S5400, the aircraft flight path prediction apparatus 1200 may generate a predicted flight path of the target aircraft from the data of the target aircraft, based on the pre-trained flight path prediction model.

In an embodiment, the aircraft flight path prediction apparatus 1200 may predict the flight path of the target aircraft from the preprocessed data of the aircraft, using the trained flight path prediction model.

In an embodiment, the flight path of the target aircraft predicted by the flight path prediction model may be expressed as in Equation 2 above.

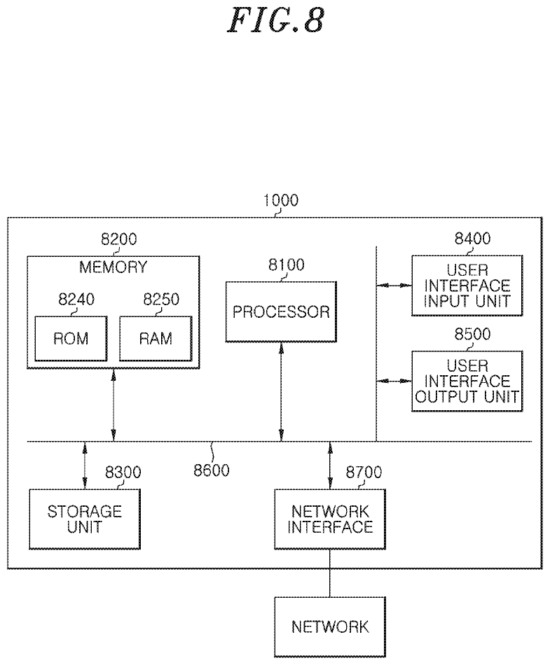

FIG. 8 is a block diagram of an aircraft flight path prediction system according to another embodiment.

As shown in FIG. 8, each of the flight path prediction model training apparatus 1100 and the aircraft flight path prediction apparatus 1200 included in the aircraft flight path prediction system 1000 may include at least one or more elements among a processor 8100, a memory 8200, a storage unit 8300, a user interface input unit 8400, and a user interface output unit 8500, and these may communicate with each other via a bus 8600. Furthermore, each of the flight path prediction model training apparatus 1100 and the aircraft flight path prediction apparatus 1200 included in the aircraft flight path prediction system 1000 may also include a network interface 8700 for connecting to a network. The processor 8100 may be a CPU or a semiconductor device that executes processing instructions stored in the memory 8200 and/or the storage 8300. The memory 8200 and the storage unit 8300 may include various types of volatile/non-volatile storage media. For example, the memory may include a ROM 8240 and a RAM 8250.

The apparatuses described above may be implemented with hardware components, software components, and/or a combination of hardware and software components. For example, the apparatuses and components described in the embodiments may be implemented using one or more general-purpose computers or special-purpose computers, such as, for example, a processor, a controller, an ALU (arithmetic logic unit), a digital signal processor, a microcomputer, an FPA (field programmable array), a PLU (programmable logic unit), a microprocessor, or any other device capable of executing instructions and responding. The processing device may execute an operating system (OS) and one or more software applications running on the operating system.

Furthermore, the processing device may access, store, manipulate, process, and generate data in response to the execution of software. For ease of understanding, although cases where one processing device is used have been described, a person skilled in the art will understand that the processing device may include a plurality of processing elements and/or a plurality of types of processing elements. For example, the processing device may include a plurality of processors or one processor and one controller. Furthermore, other processing configurations, such as a parallel processor, are also possible.

Software may include a computer program, code, instructions, or a combination of one or more of these, and may configure the processing device to operate as desired or command the processing device independently or collectively. The software and/or data may be permanently or temporarily embodied in any type of machine, component, physical device, virtual equipment, computer storage medium or device, or transmitted signal wave, to be interpreted by the processing device or to provide instructions or data to the processing device. The software may be distributed over networked computer systems and stored or executed in a distributed manner. The software and data may be stored on one or more computer-readable recording media.

The above description is merely illustrative of the technical spirit of the disclosure, and various modifications and variations will be possible for those skilled in the art to which the disclosure pertains without departing from the essential qualities of the disclosure. Therefore, the embodiments disclosed in this specification are not for limiting the technical spirit of the disclosure but for explaining it, and the scope of the technical spirit of the disclosure is not limited by these embodiments. The scope of protection of the invention should be construed by the claims below, and all technical ideas within the scope equivalent thereto should be construed as being included in the scope of the invention.

What is claimed is:

1. A method for training a flight path prediction model to be performed by a flight path prediction model training apparatus, the method comprising:
acquiring a plurality of training data sets including performance information of at least one aircraft, fuel information, weather information according to a position of the at least one aircraft, and route deviation information of the at least one aircraft;
performing preprocessing on the plurality of training data sets; and
training the flight path prediction model to predict a flight path of an aircraft based on the preprocessed plurality of training data sets.

2. The method of claim 1, wherein the performing of the preprocessing includes filtering, from the plurality of training data sets, at least one training data set that includes route deviation information exceeding a preset route deviation threshold, and
wherein the training of the flight path prediction model includes training the flight path prediction model based on the filtered plurality of training data sets.

3. The method of claim 1, wherein the performing of the preprocessing includes normalizing the performance information, the fuel information, the weather information according to the position of the at least one aircraft, and the route deviation information included in the plurality of training data sets.

4. The method of claim 1, wherein the flight path prediction model is a time-series data prediction model.

5. The method of claim 4, wherein the time-series data prediction model is a Long Short-Term Memory (LSTM) or a Recurrent Neural Network (RNN).

6. A method for predicting an aircraft flight path to be performed by an aircraft flight path prediction apparatus, the method comprising:
acquiring performance information of a target aircraft, weather information at a first position of the target aircraft, and route deviation information of the target aircraft; and
predicting a flight path of the target aircraft from preprocessed performance information, weather information, and route deviation information, based on a flight path prediction model trained by the method of claim 1.

7. The method of claim 6, further comprising acquiring flight plan information of the target aircraft and flight information of the target aircraft at the first position,
wherein the acquiring of the performance information of the target aircraft, the weather information at the first position of the target aircraft, and the route deviation information includes calculating the route deviation information based on the flight plan information and the flight information.

8. The method of claim 7, wherein the performance information includes at least one of a maximum take-off weight and a cruise speed,
wherein the weather information includes at least one of a wind direction and a wind speed,
wherein the route deviation information is a conformance metric including at least one of Cross-Track Error (CTE), Along-Track Error (ATE), Horizontal Error (HE), Altitude Error (AE), Euclidean Error (EE), and Direction Angle Error (DAE), and
wherein the flight information includes at least one of a latitude, a longitude, a bearing, a speed, a remaining fuel amount, and a heading direction of the target aircraft.

9. A flight path prediction model training apparatus, comprising:
a memory including instructions; and
a processor that executes the instructions to:
acquire a plurality of training data sets including performance information of at least one aircraft, fuel information, weather information according to a position of the at least one aircraft, and route deviation information of the at least one aircraft;
perform preprocessing on the plurality of training data sets; and
train a flight path prediction model to predict a flight path of an aircraft based on the preprocessed plurality of training data sets.

10. The apparatus of claim 9, the processor that executes the instructions to:
filter, from the plurality of training data sets, at least one training data set that includes route deviation information exceeding a preset route deviation threshold, and
train the flight path prediction model based on the filtered plurality of training data sets.

11. The apparatus of claim 9, the processor that executes the instructions to:
normalize the performance information, the fuel information, the weather information according to the position of the at least one aircraft, and the route deviation information included in the plurality of training data sets.

12. The apparatus of claim 9, wherein the flight path prediction model is a time-series data prediction model.

13. The apparatus of claim 9, wherein the time-series data prediction model is a Long Short-Term Memory (LSTM) or a Recurrent Neural Network (RNN).
